(19) United States
(12) Patent Application Publication
(10) Pub. No.: US 2021/0362374 A1
(43) Pub. Date: Nov. 25, 2021

(54) METHOD OF KNEADING AND KNEADED MATERIAL

(71) Applicant: Shibaura Machine Co., Ltd., Tokyo (JP)

(72) Inventors: Takafumi Sameshima, Numazu, Shizuoka (JP); Yoshio Iizuka, Numazu, Shizuoka (JP); Kaho Osada, Numazu, Shizuoka (JP)

(21) Appl. No.: 17/045,242

(22) PCT Filed: Mar. 25, 2019
(86) PCT No.: PCT/JP2019/012613

§ 371 Date: Oct. 5, 2020

(30) Foreign Application Priority Data
Apr. 9, 2018 (JP) 2018-074785
Jun. 6, 2018 (JP) 2018-109050

(51) Int. Cl. B29B 7/42; B29B 7/48; C08L 23/12; C08J 3/20

(52) U.S. Cl. CPC B29B 7/426; B29B 7/48; B29B 7/429; B29K 2023/12; C08L 23/12; C08J 3/203; B29B 7/489

(57) ABSTRACT

A kneading method includes conveying a raw material along a conveyance path; and increasing the raw material in pressure by restricting a conveyer from conveying the raw material by a barrier, causing the raw material with an increased pressure to flow into a passage from an inlet located at the conveyer, circulating the raw material having flowed into the passage to an outlet in the same direction as the conveying direction of the conveyer, and causing the raw material having circulated in the passage to flow out from the outlet to the outer circumference of a screw body. The raw material includes a polypropylene-based resin composition containing polypropylene and olefin rubber.

### CROSS-REFERENCE TO RELATED APPLICATIONS

This application is a national stage application of International Application No. PCT/JP2019/012613, filed Mar. 25, 2019, which designates the United States, incorporated herein by reference, and which claims the benefit of priority from Japanese Patent Application Nos. 2018-074785, filed Apr. 9, 2018, and 2018-109050, filed Jun. 6, 2018, the entire contents of which are incorporated herein by reference.

### TECHNICAL FIELD

This disclosure relates to a method of kneading and a kneaded material.

### BACKGROUND

Polypropylene-based resin compositions are widely used in various industrial fields due to its excellent mechanical property. For example, automobile's exterior members required to have high rigidity and impact strength include a polypropylene resin containing ethylene propylene diene rubber and talc.

A resin composition is produced by kneading a resin and an additive. As one example of such a technique, preliminarily kneading a molten raw material and continuously kneading the material to produce a resin composition is disclosed (in Japanese Laid-open Patent Application Publication No. 2015-227052). JP '052 describes a structure including a screw that kneads and conveys a raw material. The screw includes a screw body that rotates about an axis extending in the material conveying direction, a conveyer that conveys the raw material in a conveyance path formed between an outer circumference of the screw body and an inner circumference of a cylinder in the conveying direction, a barrier that restricts the conveyer from conveying the raw material in the conveying direction, and a passage located inside the screw body, through which the raw material is introduced from an inlet, open to the outer circumference of the screw body, and flows to an outlet. The passage extends across the barrier inside the screw body.

However, kneading the resin as a raw material with the screw illustrated in FIGS. 5 to 11 of JP '052 may significantly elongate the length of the passage through which the raw material circulates, thereby increasing flow resistance. This may cause an insufficient elongation effect to the raw material, which makes it difficult to form a kneaded material having a higher mechanical property.

Also, kneading the resin as a raw material with the screw illustrated in FIGS. 19 to 27 of JP '052 may advance deterioration of the raw material due to shearing action that occurs at the time of the resin's running over the barrier, which makes it difficult to form a kneaded material having a higher mechanical property.

It is thus difficult to improve the mechanical property of a kneaded material of a resin composition by the conventional kneading method with a screw.

It could therefore be helpful to provide a method of kneading that can provide a kneaded material having a higher mechanical property, and a kneaded material.

### SUMMARY

We thus provide:

A kneading method is for kneading and conveying a raw material and continuously discharging a produced kneaded material with a screw of an extruder. The screw includes a screw body that rotates about a linear axis in a conveying direction of the raw material; a conveyer that extends in an axial direction of the screw body, and conveys, along with rotation of the screw body, the raw material along an outer circumference of the screw body in the axial direction; a barrier that is provided in the screw body at a position adjacent to the conveyer, and restricts conveyance of the raw material in the axial direction; and a passage that extends across the barrier inside the screw body, and connects an inlet and an outlet that are open to the outer circumference of the screw body. The kneading method includes a passage conveying step of conveying the raw material along a conveyance path; and a passage circulating step of increasing the raw material in pressure by restricting the conveyer from conveying the raw material by the barrier, causing the raw material with an increased pressure to flow into the passage from the inlet located at the conveyer, circulating the raw material having flowed into the passage to the outlet in the same direction as the conveying direction of the conveyer, and causing the raw material having circulated in the passage to flow out from the outlet to the outer circumference of the screw body. The raw material includes a polypropylene-based resin composition containing polypropylene and olefin rubber.

### BRIEF DESCRIPTION OF THE DRAWINGS

FIG. 1 is a schematic diagram illustrating a high shearing device (kneading device) to implement a method of kneading according to an example.

FIG. 2 is a cross-sectional view of a first extruder.

FIG. 3 is a perspective view illustrating the first extruder with two screws engaging with each other.

FIG. 4 is a cross-sectional view of a third extruder.

FIG. 5 is a cross-sectional view of a second extruder.

FIG. 6 is a cross-sectional view of the second extruder together with a barrel and a screw.

FIG. 7 is a cross-sectional view of FIG. 6 along the line F7-F7.

FIG. 8 is a perspective view of a cylindrical member.

FIG. 9 is a side view of the screw, illustrating the flowing direction of a raw material with respect to the screw.

FIG. 10 is a cross-sectional view of the second extruder, illustrating the flowing direction of the raw material while the screw rotates.

FIG. 11 is a diagram illustrating results of evaluation.

FIG. 12 illustrates an image of a kneaded material formed in a first example.

FIG. 13 illustrates an image of a material.

### REFERENCE NUMERALS

### 21 SCREW

### 37 SCREW BODY

### 81 CONVEYER

### 82 BARRIER

### 88 PASSAGE

### 53 CONVEYANCE PATH

### DETAILED DESCRIPTION

The following will describe a method of kneading according to an example in detail with reference to the accompanying drawings.

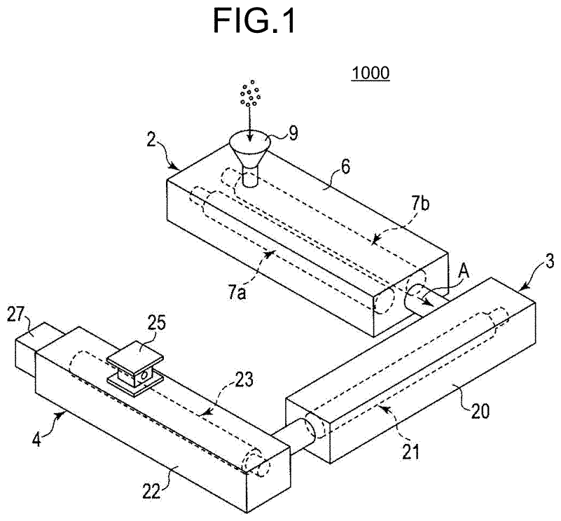

First, a kneading device that implements a method of kneading an example is described. FIG. 1 is a schematic diagram illustrating an exemplary high shearing device 1000 that implements the method of kneading according to that example.

The high shearing device 1000 includes a first extruder (processing machine) 2, a second extruder 3, and a third extruder (defoaming machine) 4. The first extruder 2, the second extruder 3, and the third extruder 4 are connected to each other in series.

The first extruder 2 serves as a processing machine for preliminarily kneading and melting materials such as two kinds of immiscible resin, for example. Examples of the two kinds of resin include polypropylene (PP) and olefin rubber. The olefin rubber is specifically ethylene propylene diene rubber (EPDM). The materials to be introduced into the first extruder may further include other materials. For example, the materials may include talc (hydrated magnesium silicate (Mg₃Si₄O₁₀(OH)₂)) or the like.

The first extruder 2 may be supplied with the respective materials or at least two materials in the form of a pellet.

In this example, the first extruder 2 is exemplified by a unidirectional rotation type, twin-screw extruder for the purpose of enhancing the degree at which supplied materials are kneaded and melted.

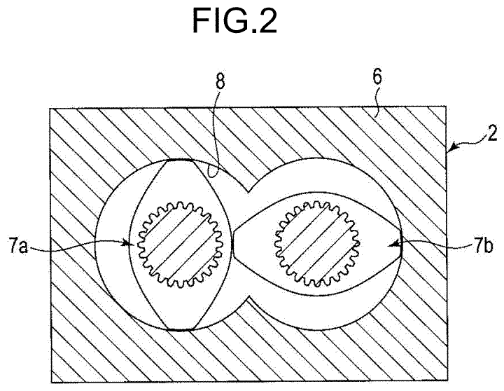

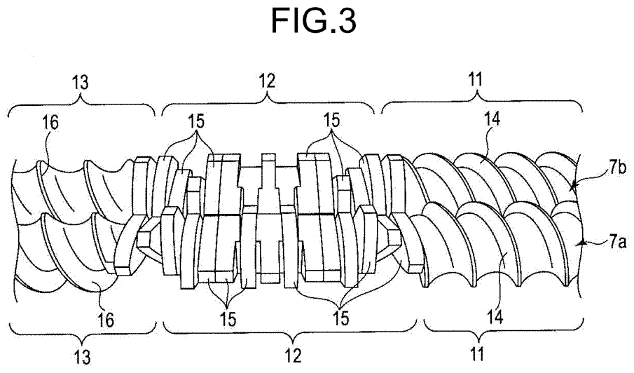

FIGS. 2 and 3 are schematic diagrams illustrating an exemplary twin-screw extruder. The twin-screw extruder includes a barrel 6, and two screws 7a and 7b housed inside the barrel 6. The barrel 6 includes a cylinder 8 having a shape of two combined cylinders. The material is continuously supplied to the cylinder 8 through a supply port 9 located at one end of the barrel 6. The barrel 6 also incorporates a heater that works to melt a resin contained in the supplied material.

The screws 7a and 7b are accommodated in the cylinder 8 while engaged with each other. The screws 7a and 7b are rotated in the same direction by receiving torque from a motor (not illustrated). As illustrated in FIG. 3, each of the screws 7a and 7b includes a feeder 11, a kneader 12, and a pump unit 13. The feeder 11, the kneader 12, and the pump unit 13 are juxtaposed in a row along the axes of the screws 7a and 7b.

The feeder 11 includes a spirally twisted flight 14. The flights 14 of the screws 7a and 7b are rotated while engaged with each other, are supplied with the material from the supply port 9, and convey the material to the kneader 12.

The kneader 12 includes a plurality of disks 15 juxtaposed along the axes of the screws 7a and 7b. The disks 15 of the screws 7a and 7b are rotated while opposing each other, and serve to preliminarily knead a raw material fed from the feeder 11. Along with the rotation of the screws 7a and 7b, the kneaded raw material is delivered to the pump unit 13.

The pump unit 13 includes a spirally twisted flight 16. The flights 16 of the screws 7a and 7b are rotated while engaged with each other, and extrude the preliminarily kneaded raw material from a discharge end of the barrel 6.

According to such a twin-screw extruder, the material is supplied to the feeders 11 of the screws 7a and 7b and molten by shearing heat generated from the rotation of the screws 7a and 7b and by the heat from the heater. The material containing a resin molten by preliminary kneading of the twin-screw extruder serves as a blended raw material. As indicated by the arrow A in FIG. 1, the raw material is continuously supplied to the second extruder 3 from the discharge end of the barrel 6.

In this example, a polypropylene-based resin composition is molten, preliminarily kneaded, and supplied to the second extruder 3 as a raw material.

The polypropylene-based resin composition contains polypropylene and olefin rubber. For example, the polypropylene-based resin composition represents a thermoplastic resin containing polypropylene (PP) and ethylene propylene diene rubber (EPDM) as principal components. In other words, the polypropylene-based resin composition contains EPDM as a continuous phase and PP dispersed in the continuous phase. Specifically, the polypropylene-based resin composition refers to a thermoplastic resin containing PP of 25 mass % or more and 90 mass % or less, ethylene propylene diene rubber of 0.1 mass % or more and 40 mass % or less, and talc (hydrated magnesium silicate (Mg₃Si₄O₁₀(OH)₂)) of 5 mass % or more and 55 mass % or less.

Thus, the material to be supplied to the first extruder 2 may be any constituent material of the raw material being a polypropylene-based resin composition, as described above.

The first extruder 2, that is, the twin-screw extruder is capable of not only melting the resin contained in the supplied material but also applying shearing action to the resin. Thus, the raw material is kneaded by the first extruder 2 and supplied to the second extruder 3. When supplied to the second extruder 3, the raw material is preliminarily kneaded and molten by the first extruder 2 and is maintained at optimum viscosity. Further, the first extruder 2 being the twin-screw extruder can stably and continuously supply a given amount of raw material to the second extruder 3 per unit time. This can lower a burden on the second extruder 3 that works to knead the raw material on a full scale.

The second extruder 3 is an element that creates a kneaded material having a microscopic dispersion structure in which polymer components of the raw material are nano-dispersed. In this example, the second extruder 3 is exemplified by a single-screw extruder.

The single-screw extruder includes a barrel 20 and one screw 21. The screw 21 functions to repeatedly apply a shearing action and an elongation effect to the molten raw material. The structure of the second extruder 3 including the screw 21 will be described later in detail.

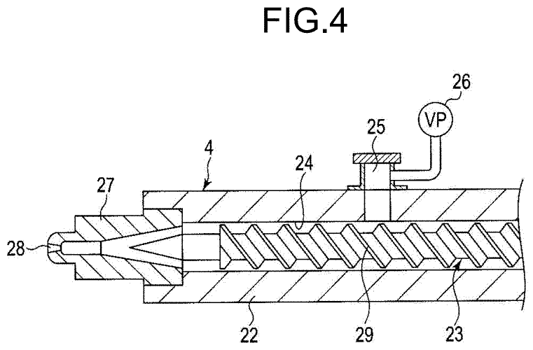

The third extruder 4 is an element that suctions and removes gas components from the kneaded material discharged from the second extruder 3. In this example, the third extruder 4 is exemplified by a single-screw extruder. As illustrated in FIG. 4, the single-screw extruder includes a barrel 22 and one vented screw 23 housed in the barrel 22. The barrel 22 includes a cylinder 24 having a straight cylindrical shape. The kneaded material is extruded from the second extruder 3 and continuously supplied to the cylinder 24 from one axial end.

The barrel 22 includes a vent 25. The vent 25 is open to an intermediate part of the cylinder 24 in the axial direction and connected to a vacuum pump (VP) 26. The other end of the cylinder 24 of the barrel 22 is closed by a head 27. The head 27 is provided with a discharge outlet 28 from which the kneaded material is discharged.

The vented screw 23 is housed in the cylinder 24. The vented screw 23 is rotated in one direction by receiving torque from a motor (not illustrated). The vented screw 23 includes a spirally twisted flight 29. The flight 29 rotates together with the vented screw 23, and continuously conveys the kneaded material supplied to the cylinder 24 to the head 27. The kneaded material receives vacuum pressure from the vacuum pump 26 when conveyed to the location corresponding to the vent 25. That is, the vacuum pump works to place the cylinder 24 under a negative pressure, thereby continuously suctioning and removing gaseous substances and other volatile components from the kneaded material. The kneaded material including no gaseous substances and other volatile components is continuously discharged from the discharge outlet 28 of the head 27.

Next, the second extruder 3 is described in detail.

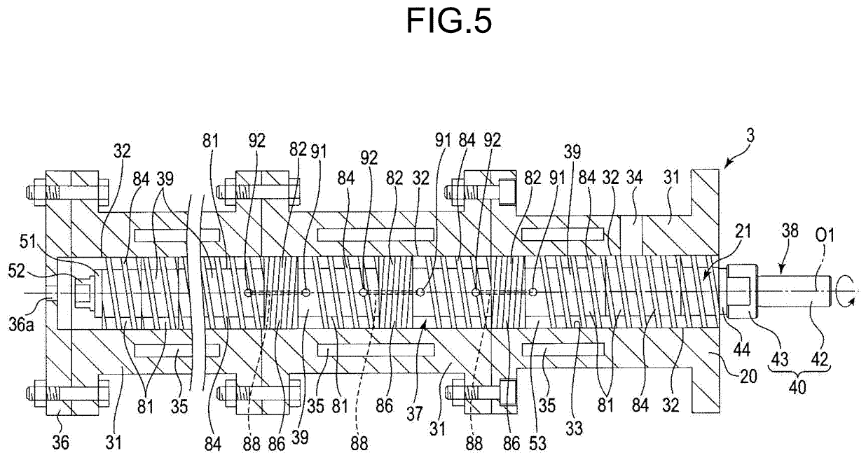

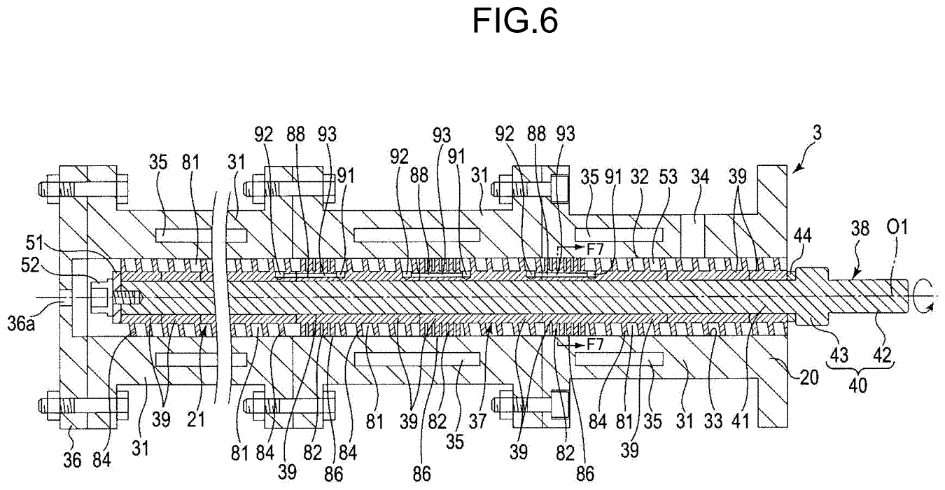

As illustrated in FIGS. 5 and 6, the barrel 20 of the second extruder 3 has a straight tubular shape, and is horizontally placed. The barrel 20 is divided into a plurality of barrel elements 31.

Each of the barrel elements 31 is provided with a through hole 32 having a cylindrical shape. The barrel elements 31 are joined together by bolt fastening so that the respective through holes 32 are coaxially continuous to one another. The through holes 32 of the barrel elements 31 in cooperation define a cylinder 33 having a cylindrical shape inside the barrel 20. The cylinder 33 extends in the axial direction of the barrel 20.

The barrel 20 is provided with a supply port 34 at one axial end. The supply port 34 communicates with the cylinder 33, and is continuously supplied with the raw material blended by the first extruder 2.

The barrel 20 is equipped with a heater (not illustrated). The heater adjusts the temperature of the barrel 20 to a controlled value to knead the raw material. The barrel 20 further includes a refrigerant path 35 through which a refrigerant such as water or oil flows, for example. The refrigerant path 35 is placed to surround the cylinder 33. The refrigerant flows along the refrigerant path 35 at the time when the temperature of the barrel 20 exceeds a preset upper limit value to forcibly cool the barrel 20.

The other axial end of the barrel 20 is closed by a head 36. The head 36 is provided with a discharge outlet 36a. The discharge outlet 36a is opposite to the supply port 34 in the axial direction of the barrel 20, and connected to the third extruder 4.

As illustrated in FIGS. 5 and 6, the screw 21 includes a screw body 37. According to this example, the screw body 37 includes one rotor shaft 38 and a plurality of cylindrical members 39 having a cylindrical shape.

The rotor shaft 38 includes a first shaft 40 and a second shaft 41. The first shaft 40 is located at a base end of the rotor shaft 38 at one end of the barrel 20. The first shaft 40 includes a joint 42 and a stopper 43. The joint 42 is coupled to a power source such as a motor via a coupling (not illustrated). The stopper 43 is coaxially placed with respect to the joint 42. The stopper 43 is larger in diameter than the joint 42.

The second shaft 41 coaxially extends from an end face of the stopper 43 of the first shaft 40. The second shaft 41 has a length corresponding to substantially a total length of the barrel 20, and has a distal end facing the head 36. A straight axis O1 coaxially passes through the first shaft 40, and the second shaft 41 extends horizontally along the axis of the rotor shaft 38.

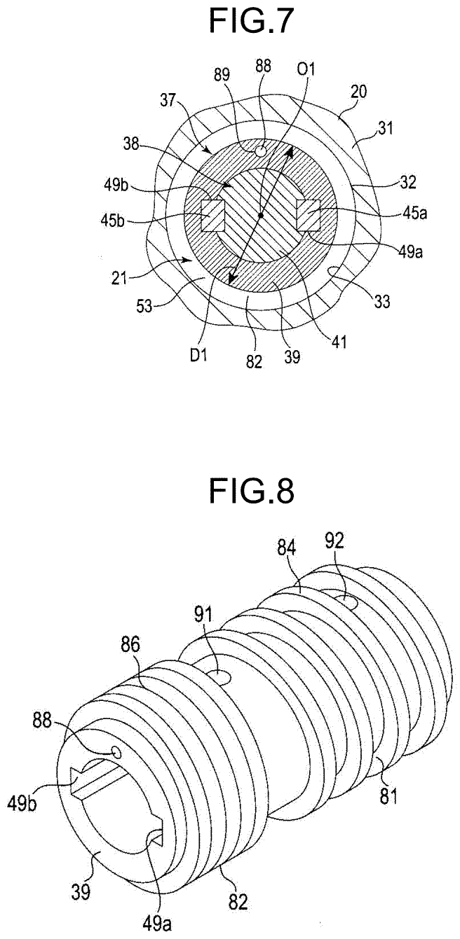

The second shaft 41 has a solid columnar shape is smaller in diameter than the stopper 43. As illustrated in FIG. 7, a pair of keys 45a and 45b is attached to the outer circumference of the second shaft 41. The keys 45a and 45b are circumferentially offset from each other by 180 degrees on the second shaft 41 and extend in the axial direction.

As illustrated in FIGS. 6 and 7, the cylindrical members 39 allow the second shaft 41 to coaxially pass therethrough. The inner circumference of each cylindrical member 39 is provided with a pair of key grooves 49a and 49b. The key grooves 49a and 49b are circumferentially offset from each other by 180 degrees in the cylindrical member 39 and extend in the axial direction.

While the key grooves 49a and 49b are aligned with the keys 45a and 45b of the second shaft 41, the cylindrical member 39 is inserted above the second shaft 41 from the distal end. In this example, a first collar 44 extends between the initially inserted one of the cylindrical members 39 above the second shaft 41 and the end face of the stopper 43 of the first shaft 40. After all of the cylindrical members 39 are inserted above the second shaft 41, a fixing screw 52 is screwed into a distal end face of the second shaft 41 via a second collar 51.

By screwing, all of the cylindrical members 39 are fastened tightly in the axial direction of the second shaft 41 between the first collar 44 and the second collar 51, and the end faces of the adjacent cylindrical members 39 are in tight contact with each other without a gap.

All of the cylindrical members 39 are now coaxially joined together on the second shaft 41, and the cylindrical members 39 and the rotor shaft 38 are assembled in a unified manner. This enables the respective cylindrical members 39 to be rotated about the axis O1 together with the rotor shaft 38, that is, the screw body 37 to be rotated about the axis O1.

In this state, the respective cylindrical members 39 serve as a constituent element that defines an outer diameter D1, as shown in FIG. 7, of the screw body 37. That is, the cylindrical members 39 coaxially joined together along the second shaft 41 are set to the same outer diameter D1. The outer diameter D1 of the screw body 37 (respective cylindrical members 39) is a defined diameter passing through the axis O1 being the rotational center of the rotor shaft 38.

Thereby, a segmented screw 21 including the screw body 37 (respective cylindrical member 39) with the outer diameter D1 of a constant value is formed. The segmented screw 21 can hold a plurality of screw elements in any order and any combination along the rotor shaft 38 (that is, the second shaft 41). The cylindrical member 39 including at least part of flights 84 and 86 (described later) can be, for example, defined as one screw element.

Thus, by segmenting the screw 21, for example, the screw 21 can be greatly improved in convenience in terms of changing or adjusting the specifications or repair and maintenance of the screw 21.

Moreover, the segmented screw 21 is coaxially accommodated in the cylinder 33 of the barrel 20. Specifically, the screw body 37 holding the screw elements along the rotor shaft 38 (second shaft 41) is rotatably accommodated in the cylinder 33. In this state, the first shaft 40 (joint 42 and stopper 43) of the rotor shaft 38 projects from one end of the barrel 20 to the outside of the barrel 20.

In this state, there is a conveyance path 53 between the outer circumference of the screw body 37 and the inner circumference of the cylinder 33 for conveying the raw material. The conveyance path 53 has an annular cross-sectional shape in the radial direction of the cylinder 33, and extends in the axial direction of the cylinder 33.

As illustrated in FIGS. 5 to 8, the screw body 37 includes a plurality of conveyers 81 that conveys the raw material, and a plurality of barriers 82 that restricts the raw material from flowing. That is, two or more conveyers 81 are located at the base end corresponding to one end of the barrel 20, and two or more conveyers 81 are located at the distal end of the screw body 37 corresponding to the other end of the barrel 20. Between these conveyers 81, the conveyers 81 and the barriers 82 are alternately juxtaposed in the axial direction from the base end to the distal end of the screw body 37.

The supply port 34 of the barrel 20 is open to the conveyers 81 located at the base end of the screw body 37.

Each of the conveyers 81 includes the spirally twisted flight 84. The flight 84 projects toward the conveyance path 53 from the outer circumference of the cylindrical member 39. The flight 84 is twisted to convey the raw material from the base end to the distal end of the screw body 37 when the screw 21 rotates leftward or counterclockwise, when viewed from the base end of the screw body 37. That is, the flight 84 is twisted rightward as with a right-hand screw.

Each of the barriers 82 includes the spirally twisted flight 86. The flight 86 projects toward the conveyance path 53 from the outer circumference of the cylindrical member 39. The flight 86 is twisted to convey the raw material from the distal end to the base end of the screw body 37 when the screw 21 rotates leftward or counterclockwise, when viewed from the base end of the screw body 37. That is, the flight 84 is twisted leftward as with a left-hand screw.

A twisting pitch of the flight 86 of each barrier 82 is set equal to or smaller than a twisting pitch of the flight 84 of the conveyer 81. Moreover, there is a small clearance ensured between the top parts of the flights 84 and 86 and the inner circumference of the cylinder 33 of the barrel 20. In this example, the clearance between an outer diameter part of the barrier 82 (top part of the flight 86) and the inner circumference of the cylinder 33 is preferably 0.1 mm or more to 2 mm or less. More preferably, the clearance is 0.1 mm or more to 0.7 mm or less. Thereby, the clearance can ensure the limitation to the conveyance of the raw material therethrough.

The length of the conveyer 81 along the axis of the screw body 37 is appropriately in accordance with a kind of the raw material or a kneading degree of the raw material, or a production volume of the kneaded material per unit time, for example. The conveyer 81 refers to a region, including the flight 84, in at least the outer circumference of the cylindrical member 39, however, it is not limited to a region between the starting point and the end point of the flight 84.

That is, the region in the outer circumference of the cylindrical member 39 other than the flight 84 may also be regarded as the conveyer 81. For example, a spacer or a collar of a cylindrical shape may be placed adjacent to the cylindrical member 39 including the flight 84. In such a configuration the spacer or the collar may be regarded as the conveyer 81.

Further, the length of the barrier 82 along the axis of the screw body 37 is appropriately set in accordance with a kind of the raw material or a kneading degree of the raw material, or a production volume of the kneaded material per unit time, for example. The barrier 82 blocks the flow of the raw material delivered by the conveyer 81. That is, the barrier 82 is adjacent to the conveyer 81 on a downstream side in the material conveying direction, and prevents the raw material delivered by the conveyer 81 from passing through the clearance between the top part of the flight 86 and the inner circumference of the cylinder 33.

In the screw 21 described above, the respective flights 84 and 86 project toward the conveyance path 53 from the outer circumferences of the cylindrical members 39 having the same outer diameter D1 as shown in FIG. 7. Thus, the outer circumference of each cylindrical member 39 defines a root diameter of the screw 21. The root diameter of the screw 21 is maintained at a constant value along the total length of the screw 21.

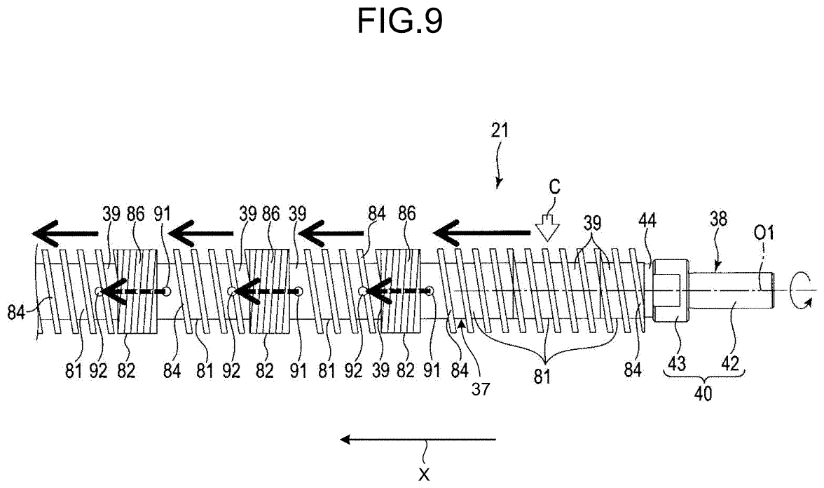

As illustrated in FIGS. 5, 6, and 9, the screw body 37 is provided with a plurality of passages 88 extending in the axial direction of the screw body 37. In other words, inside the screw body 37 the passages 88 are set in series at given intervals in the material conveying direction or the axial direction as shown by the direction indicated by arrow X in FIG. 9.

In this example, in the unit including one barrier 82 and two conveyers 81 holding the barrier 82 therebetween, the passages 88 extend between the cylindrical members 39 of both of the conveyers 81 and the cylindrical member 39 of the barrier 82. In this example, the passages 88 are aligned in a row at given intervals (for example, at regular intervals) on the same straight line in the axial direction of the screw body 37.

Further, the passages 88 are located eccentrically from the axis O1 of the rotor shaft 38 inside the cylindrical member 39. In other words, the passages 88 are deviated from the axis O1, and revolve around the axis O1 along with the rotation of the screw body 37.

As illustrated in FIG. 7, the passage 88 is exemplified by a hole having a circular cross-sectional shape. The inner diameter of the passage 88 is, for example, 1 mm or more and 8 mm or less, preferably, 1 mm or more and 5 mm or less, and more preferably, 3 mm.

The cylindrical members 39 of the conveyer 81 and the barrier 82 each have a tubular wall surface 89 that defines the hole. That is, the passage 88 is a hole or a hollow space, and the wall surface 89 continuously surrounds the hollow passage 88 in the circumferential direction. Thereby, the passage 88 is a hollow space that allows circulation of the raw material alone. In other words, inside the passage 88 no other elements of the screw body 37 are present. Along with the rotation of the screw body 37, the wall surface 89 does not rotate about the axis O1 but revolves around the axis O1.

As illustrated in FIGS. 5, 6, 9, and 10, each of the passages 88 includes an inlet 91, an outlet 92, and a main passage 93 that connects the inlet 91 and the outlet 92. The inlet 91 and the outlet 92 are close to both sides of each barrier 82. In other words, the main passage 93 connecting the inlet 91 and the outlet 92 is located across the barrier 82 inside the screw body 37. From another viewpoint, in each conveyer 81 adjacent to two adjacent barriers 82, the inlet 91 is open to the outer circumference of the conveyer 81 in the vicinity of the downstream end, while the outlet 92 is open to the outer circumference of the conveyer 81 in the vicinity of the upstream end.

The main passage 93 extends straight in the axial direction of the screw body 37 without branching. By way of example, the drawings depict that the main passage 93 extends in parallel with the axis O1. Both sides of the main passage 93 are closed in the axial direction.

The outlet 92 of each passage 88 is located upstream of the inlet 91 of the adjacent passage 88 on a downstream side in the material conveying direction as shown in the direction indicated by arrow X.

Specifically, the inlet 91 is located at one side of the main passage 93, that is, a part close to the base end of the screw body 37. In this example, the inlet 91 may be open to the outer circumference of the screw body 37 from an end face of the main passage 93, or from a part close to one end face of the main passage 93, that is, a part before the end face. The direction in which the inlet 91 opens is not limited to a direction orthogonal to the axis O1, but may be a direction intersecting with the axis O1. In this example, two or more inlets 91 may be formed by opening the main passage 93 from one side in two or more directions.

The outlet 92 is located at the other side (opposite to the one side) of the main passage 93, that is, a part close to the distal end of the screw body 37. In this example, the outlet 92 may be open to the outer circumference of the screw body 37 from the other end face of the main passage 93, or from a part close to the other end face of the main passage 93, that is, a part before the end face. The direction in which the outlet 92 opens is not limited to a direction orthogonal to the axis O1, but may be a direction intersecting with the axis O1. In this example, two or more outlets 92 may be formed by opening the main passage 93 from one side in two or more directions.

The main passage 93 connecting the inlet 91 and the outlet 92 traverses the barrier 82 in each unit, and has a length to extend between the two conveyers 81 across the barrier 82. In this example, the aperture of the main passage 93 may be smaller than or equal to the aperture of the inlet 91 and the outlet 92. In either situation, the cross-sectional area of the passage defined by the aperture of the main passage 93 is set much smaller than the annular cross-sectional area of the annular conveyance path 53 in the radial direction.

In this example, when the screw 21 is disassembled by removing the cylindrical members 39 including the flights 84 and 86 from the rotor shaft 38, the cylindrical member 39 including at least part of the flights 84 and 86 can be referred to as a screw element.

That is, the screw body 37 of the screw 21 can be formed by successively disposing the cylindrical members 39 serving as screw elements on the outer circumference of the rotor shaft 38. This makes it possible to replace or rearrange the conveyers 81 and the barriers 82 depending on the kneading degree of the raw material, for example, and facilitate replacement and rearrangement work.

The main passage 93 of the passage 88 is formed by tightening the cylindrical members 39 in the axial direction of the second shaft 41 to bring the end faces of the adjacent cylindrical members 39 into close contact with each other. The inlet 91 is communicated with the outlet 92 in the passage 88 via the main passage 93 in a unified manner. Thus, to form the passage 88 in the screw body 37, the individual cylindrical members 39 of a length greatly shorter than the total length of the screw body 37 may be subjected to processing. This can facilitate the workability and handling in forming the passage 88.

According to the high shearing device 1000 having such a structure, the first extruder 2 works to preliminarily knead a plurality of resins. The resins are kneaded and molten to a raw material having fluidity, and is continuously supplied from the first extruder 2 to the second extruder 3.

As indicated by the arrow C in FIG. 9, the raw material is supplied to the second extruder 3 and injected into the outer circumference of the conveyer 81 located at the base end of the screw body 37. Then, along with counterclockwise or leftward rotation of the screw 21 as viewed from the base end of the screw body 37, the flight 84 of the conveyer 81 continuously conveys the raw material in the conveying direction (indicated by arrow X) to the distal end of the screw body 37, as indicated by the solid-line arrow in FIG. 9.

The raw material is then subjected to a shearing action caused by a difference in velocity between the flight 84 and the inner circumference of the cylinder 33 pivoting along the conveyance path 53. The raw material is agitated by the finely twisted flight 84. As a result, the raw material is kneaded on a full scale, advancing dispersion of the polymer components (polypropylene) contained in the raw material.

Receiving the shearing action, the raw material reaches the boundary between the conveyer 81 and the barrier 82 along the conveyance path 53. The flight 86 of the barrier 82 is twisted leftward to convey the raw material from the distal end to the base end of the screw body 37 as the screw 21 rotates leftward. As a result, the flight 86 blocks the raw material from being conveyed. In other words, as the screw 21 rotates leftward, the flight 86 of the barrier 82 restricts the flow of the raw material conveyed by the flight 84 and prevents the raw material from passing through the clearance between the barrier 82 and the inner circumference of the cylinder 33.

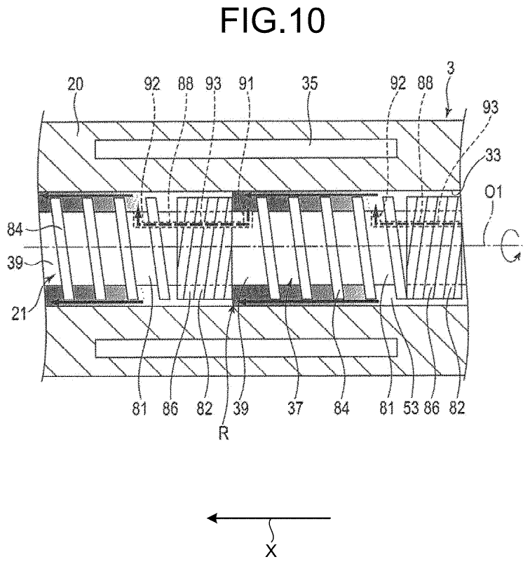

The raw material then increases in pressure at the boundary between the conveyer 81 and the barrier 82. Specifically, FIG. 10 illustrates, by gradation, a filling factor of the raw material in a part of the conveyance path 53 corresponding to the conveyer 81 of the screw body 37. That is, in the conveyance path 53 the material filling factor increases as the color tone darkens. As is apparent from FIG. 10, the material filling factor increases as the raw material approaches the barrier 82 in the conveyance path 53 corresponding to the conveyer 81. The material filling factor reaches 100% immediately before the barrier 82.

Thus, a material pool R where the material filling factor reaches 100% is formed immediately before the barrier 82. In the material pool R, the flow of the raw material is blocked so that the raw material increases in pressure. As indicated by the dashed-line arrows in FIGS. 9 and 10, the raw material with the increased pressure continuously flows into the main passage 93 through the inlet 91 open to the downstream end of the conveyer 81, and continuously circulates in the main passage 93 from the base end to the distal end of the screw body 37.

The circumferential velocity of the screw 21 is preferably 0.5 m/s or more and 3.0 m/s or less and more preferably, 0.63 m/s or more and 2.51 m/s or less.

The circumferential velocity of the screw 21 refers to that of an optional point on a distal end face of the flight 84 in the screw body 37. The distal end face of the flight 84 refers to the face of the flight 84 opposing the inner circumference of the cylinder 33. Specifically, the circumferential velocity of the screw 21 refers to the moving velocity of an optional point on the distal end face of the flight 84 of the screw body 37 per unit time (m/s). In the following, the circumferential velocity of the optional point on the distal end face of the flight 84 in the screw body 37 is simply referred to as the circumferential velocity of the screw 21.

As described above, the cross-sectional area of the passage defined by the aperture of the main passage 93 is much smaller than the annular cross-sectional area of the conveyance path 53 in the radial direction of the cylinder 33. From another viewpoint, the spread area based on the aperture of the main passage 93 is much smaller than the spread area of the annular conveyance path 53. Because of this, the raw material, when flowing into the main passage 93 from the inlet 91, is abruptly narrowed down and given an elongation effect.

Due to the passage cross-sectional area sufficiently smaller than the annular cross-sectional area, the raw material accumulated in the material pool R does not disappear. That is, part of the accumulated raw material continuously flows from the material pool R into the inlet 91. During this period, the flight 84 works to deliver a new raw material to the barrier 82. As a result, the filling factor of the material pool R immediately before the barrier 82 is constantly maintained at 100%. Some variation in amount of the raw material conveyed by the flight 84, if it occurs, is compensated by the raw material remaining in the material pool R. Thereby, the raw material can be continuously and stably supplied to the passage 88. Thus, in the passage 88 the raw material is continuously given the elongation effect without interruption.

As indicated by the solid-line arrow in FIG. 10, the raw material passes through the main passage 93 and flows out from the outlet 92. Thereby, the raw material is continuously fed back onto the outer circumference of another conveyer 81 adjacent to the barrier 82 at the distal end of the screw body 37. The raw material is fed back and continuously conveyed to the distal end of the screw body 37 by the flight 84 of another conveyer 81, and is subjected to the shearing action again while conveyed. Receiving the shearing action, the raw material flows into the main passage 93 from the inlet 91 of the next main passage 93 adjacent thereto on a downstream side in the conveying direction, and is subjected to the elongation effect again while circulated in the main passage 93.

That is, the second extruder 3 repeats a kneading process including continuous repeating kneading the raw material and circulating the raw material in the passage 88 in the conveying direction (direction indicated by arrow X) by the rotation of the screw 21.

In this example, the conveyers 81 and the barriers 82 are alternately juxtaposed in the screw body 37 in the axial direction, and the passages 88 are aligned at intervals in the screw body 37 in the axial direction. Thereby, the raw material injected into the screw body 37 from the supply port 34 is continuously conveyed in the conveying direction (direction indicated by arrow X) from the base end to the distal end of the screw body 37 while being alternately and repeatedly subjected to the shearing action and the elongation effect as illustrated in FIGS. 9 and 10. Thereby, the raw material can be kneaded at a higher degree, advancing the dispersion of the polymer components (polypropylene) in the raw material.

When reaching the distal end of the screw body 37, the raw material is a sufficiently kneaded material and is continuously supplied to the third extruder 4 through the discharge outlet 36a to continuously remove gaseous substances and other volatile components from the kneaded material.

According to the example as described above, the second extruder 3 is supplied with the raw material from the first extruder 2 and conveys the raw material in the axial direction (direction indicated by arrow X) of the screw body 37. In the conveying process the raw material is repeatedly subjected to the shearing action and the elongation effect. That is, the second extruder 3 of the example performs the kneading process including continuously repeating kneading the raw material and circulating the raw material in the passage 88 in the conveying direction (direction indicated by arrow X) by the rotation of the screw 21. Specifically, the kneading process includes a passage conveying process of conveying the raw material along the conveyance path; and a passage circulation process of increasing the pressure of the raw material by restricting, by the barrier 82, the conveyer 81 from conveying the raw material, causing the raw material with the increased pressure to flow into the passage through the inlet 91 located in the conveyer 81, circulating the raw material to the outlet 92 in the passage in the same direction as the conveying direction of the conveyer 81, and causing the circulated raw material to flow out from the outlet 92 to the outer circumference of the screw body. Thus, by the kneading method, the second extruder 3 can produce a kneaded material having a higher mechanical property through the kneading process.

That is, in the kneading method, the raw material is continuously and repeatedly subjected to the shearing action and the elongation effect while conveyed in the conveying direction X through the kneading process.

Thereby, the raw material is continuously and repeatedly given the shearing action and the elongation effect without interruption. Thus, the raw material is kneaded at a higher degree, advancing dispersion of PP (polypropylene) contained in the raw material.

Advancing dispersion of PP contained in the raw material enables production of a kneaded material having a crystal structure of more densely oriented PP crystals in nano-order, and exhibiting a higher mechanical property.

The second extruder 3 of this example prevents the raw material from circulating multiple times in the same location on the outer circumference of the screw body 37. Therefore, the second extruder 3 can supply the raw material to the third extruder 4 without interruption.

In this example, the raw material is preliminarily kneaded by the first extruder 2 and continuously supplied to the second extruder 3 without interruption. Because of this, the flow of the raw material is prevented from temporarily stagnating inside the first extruder 2. This makes it possible to prevent a change in the resin in terms of temperature, viscosity, or phase, which would otherwise occur from stagnation of the kneaded raw material in the first extruder 2. As a result, the first extruder 2 can constantly supply the raw material having uniform quality to the second extruder 3.

Additionally, according to this example, the kneaded material does not merely appear to be continuously produced but can be ultimately continuously produced. That is, the raw material is continuously conveyed among the first extruder 2, the second extruder 3, and the third extruder 4 without interruption, and alternately subjected to the shearing action and the elongation effect by the second extruder 3. Owing to such a constitution, the molten raw material is stably supplied from the first extruder 2 to the second extruder 3.

According to this example, the passage 88 applies the elongation effect to the raw material and is eccentric to the axis O1 being the rotation center of the screw body 37 and also extends in the axial direction of the screw body 37. Thus, the passage 88 revolves around the axis O1. In other words, the tubular wall surface 89 defining the passage 88 does not rotate about the axis O1 but revolves around the axis O1.

Because of this, the raw material is prevented from being intensely agitated inside the passage 88 while passing through the passage 88. This makes it difficult for the raw material to receive the shearing action while passing through the passage 88. The raw material is mainly subjected to the elongation effect while fed back to the outer circumference of the conveyer 81 through the passage 88. In the screw 21 of this example, it is thus possible to definitely determine a location where the shearing action is applied to the raw material and a location where the elongation effect is applied to the raw material.

### EXAMPLES

The following will describe examples for the purpose of explanation in detail. Our methods and materials are, however, not limited to the examples. Elements are denoted by the same reference numerals as the elements of the high shearing device 1000 in the above example.

First, the following experiments were conducted, using a composite reinforced PP (talc) grade, GT5A manufactured by KOJIMA SANGYO CO., LTD. as a material supplied to the first extruder 2. The material is in the form of pellet containing ethylene propylene diene rubber and talc kneaded into polypropylene.

### First Example

In a first example, in the high shearing device 1000 a material was poured into the first extruder 2 and preliminarily kneaded thereby, was kneaded by the second extruder 3, and was defoamed by the third extruder (defoaming machine) 4 to form a kneaded material.

The second extruder 3 was the second extruder 3 having the structure described with reference to FIG. 1 to FIG. 10.

In the first example, the second extruder 3 was under the following device condition and kneaded the material under the following kneading condition. Device Condition and Kneading Condition
Diameter (outer diameter) of screw 21: 48 mm
Effective length (L/D) of screw 21: 6.25
Circumferential velocity of screw 21: 0.63 m/s
Inner diameter of passage 88: 3 mm
Number of passages 88: 2
Material supply amount to second extruder 3 (extrusion mass): 5 kg/h
Barrel set temperature: 200 degrees C.

A twin-screw extruder TEM-26SX (screw nominal diameter of 26 mm) manufactured by TOSHIBA MACHINE CO., LTD. was used as the first extruder 2. The flight 14, the disk 15, and the flight 16 of the screws 7a and 7b served to mainly melt the material.

### Kneading Process

Under the device condition and the kneading condition as above, the raw material was kneaded by the second extruder 3 to produce a kneaded material 1.

### Evaluation

### Evaluation of Mechanical Property

The mechanical property of the kneaded material 1 produced in the first example was evaluated. In the mechanical property evaluation, the kneaded material 1 produced by the second extruder 3 under the device condition and the kneading condition was defoamed by the third extruder 4 (defoaming machine) for evaluation.

Molded articles of the material and the kneaded material 1 were used to evaluate their mechanical property. The molded articles of the material and the kneaded material 1 refer to molded articles of the material and the defoamed kneaded material 1 with an injection molding machine under the condition that a cylinder temperature is 200 degrees C. and injection speed is 40 mm/s.

In the first example, Charpy impact strength was measured as the mechanical property.

To measure the Charpy impact strength, the molded articles of the material and the defoamed kneaded material 1 were notched with a cutting tool to form Charpy impact test pieces having a thickness of 3.0 mm defined by JIS-K7111. Impact values of the test pieces were measured by a method conforming to JIS-K7111. The impact values were measured ten times to calculate an average value.

With respect to a reference value of “1” of the Charpy impact strength of the molded article of the material, a relative value of the Charpy impact strength of the molded article of the defoamed kneaded material 1 was measured. The Charpy impact strength of the molded article of the material was found as 18.28 kj/m².

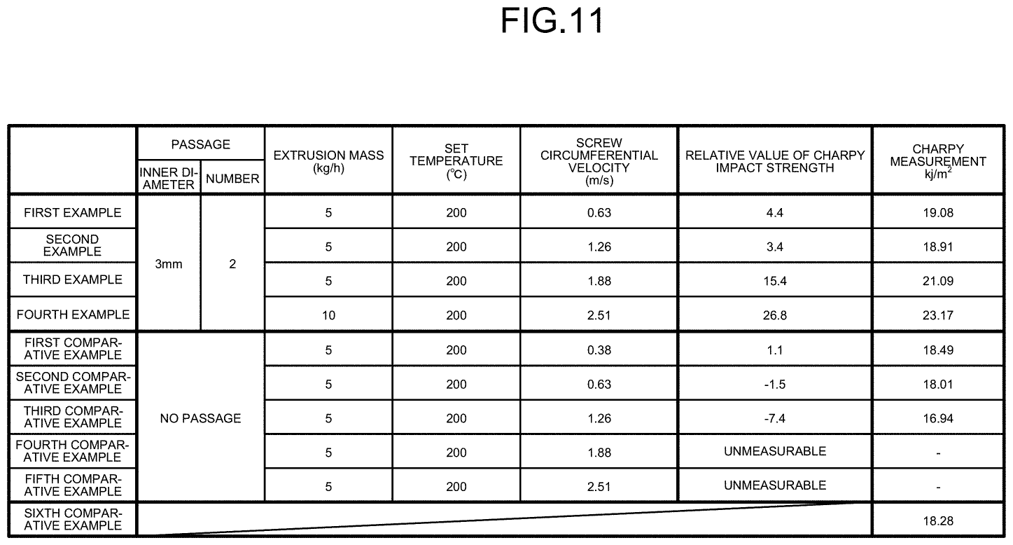

FIG. 11 illustrates a result of the evaluation.

### Evaluation of PP Dispersity

PP dispersion in the kneaded material 1 produced in the first example was evaluated through image analysis.

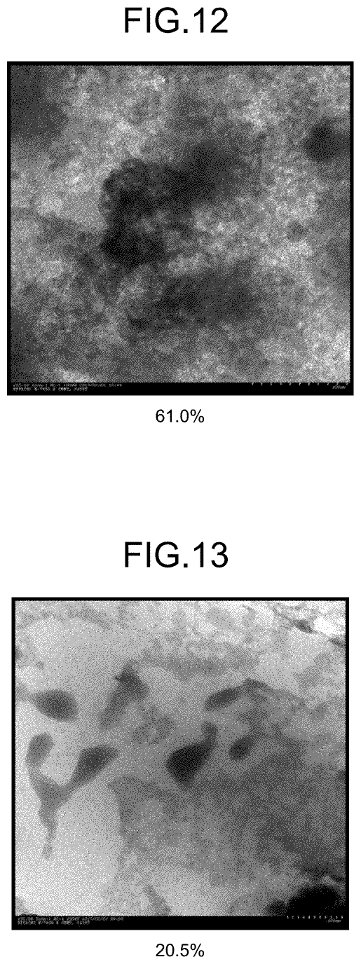

Specifically, the defoamed kneaded material 1 was imaged at magnification of 50000 with an electron microscope to calculate the ratio of a PP occupied area in the image. This procedure was conducted at three different imaging positions in the kneaded material 1, to calculate an average value of the ratios of the PP occupied area as a dispersity. FIG. 12 illustrates an image of the defoamed kneaded material 1 produced in the first example. The PP dispersity in the defoamed kneaded material 1 produced in the first example was found as 61.0%.

### Second Example

Except for the circumferential velocity of the screw body 37 set to 1.26 m/s, the raw material was kneaded with the second extruder 3 under the same device condition and the same kneading condition as in the first example. A kneaded material 2 was produced. As in the first example, the kneaded material 2 was defoamed by the third extruder (defoaming machine) 4 and the mechanical property thereof was evaluated under the same condition as in the first example. FIG. 11 illustrates a result of the evaluation.

### Third Example

Except for the circumferential velocity of the screw body 37 set to 1.88 m/s, the raw material was kneaded with the second extruder 3 under the same device condition and the same kneading condition as in the first example. A kneaded material 3 was produced. As in the first example, the kneaded material 3 was defoamed by the third extruder (defoaming machine) 4 to evaluate the mechanical property thereof under the same condition as in the first example. FIG. 11 illustrates a result of the evaluation.

### Fourth Example

Except for the extrusion mass of the second extruder 3 set to 10 kg/h and the circumferential velocity of the screw body 37 set to 2.51 m/s, the raw material was kneaded with the second extruder 3 under the same device condition and the same kneading condition as in the first example. A kneaded material 4 was produced. As in the first example, the kneaded material 4 was defoamed by the third extruder (defoaming machine) 4 to evaluate the mechanical property thereof under the same condition as in the first example. FIG. 11 illustrates a result of the evaluation.

### First Comparative Example

Except that the second extruder 3 differs from the second extruder 3 of the first example in excluding the passage 88, and the circumferential velocity of the screw body 37 was set to 0.38 m/s, the raw material was kneaded with the second extruder 3 under the same device condition and the same kneading condition as in the first example. A comparative kneaded material 1 was produced. As in the first example, the comparative kneaded material 1 was defoamed by the third extruder (defoaming machine) 4, to evaluate the mechanical property thereof under the same condition as in the first example. FIG. 11 illustrates a result of the evaluation.

### Second Comparative Example

Except that the second extruder 3 differs from the second extruder 3 of the first example in excluding the passage 88, and the circumferential velocity of the screw body 37 was set to 0.63 m/s, the raw material was kneaded with the second extruder 3 under the same device condition and the same kneading condition as in the first example. A comparative kneaded material 2 was produced. As in the first example, the comparative kneaded material 2 was defoamed by the third extruder (defoaming machine) 4, to evaluate the mechanical property thereof under the same condition as in the first example. FIG. 11 illustrates a result of the evaluation.

### Third Comparative Example

Except that the second extruder 3 differs from the second extruder 3 of the first example in excluding the passage 88, and the circumferential velocity of the screw body 37 was set to 1.26 m/s, the raw material was kneaded with the second extruder 3 under the same device condition and the same kneading condition as in the first example. A comparative kneaded material 3 was produced. As in the first example, the comparative kneaded material 3 was defoamed by the third extruder (defoaming machine) 4, to evaluate the mechanical property thereof under the same condition as that in the first example. FIG. 11 illustrates a result of the evaluation.

### Fourth Comparative Example

Except that the second extruder 3 differs from the second extruder 3 of the first example in excluding the passage 88, and the circumferential velocity of the screw body 37 was set to 1.88 m/s, the raw material was kneaded with the second extruder 3 under the same device condition and the same kneading condition as in the first example. A comparative kneaded material 4 was produced. As in the first example, the comparative kneaded material 4 was defoamed by the third extruder (defoaming machine) 4, to evaluate the mechanical property thereof under the same condition as in the first example. FIG. 11 illustrates a result of the evaluation.

### Fifth Comparative Example

Except that the second extruder 3 differs from the second extruder 3 of the first example in excluding the passage 88, and the circumferential velocity of the screw body 37 was set to 2.51 m/s, the raw material was kneaded with the second extruder 3 under the same device condition and the same kneading condition as in the first example. A comparative kneaded material 5 was produced. As in the first example, the comparative kneaded material 5 was defoamed by the third extruder (defoaming machine) 4, to evaluate the mechanical property thereof under the same condition as in the first example. FIG. 11 illustrates a result of the evaluation.

### Sixth Comparative Example

The material was used for a comparative kneaded material 6 of a sixth comparative example. The mechanical property thereof was evaluated under the same condition as in the first example. FIG. 11 illustrates a result of the evaluation.

### Comparison Among Evaluation Results

As illustrated in FIG. 11, the kneaded material 1 to the kneaded material 4 produced in the first example to the fourth example exhibited higher Charpy measurements and higher relative values of Charpy impact strength than the comparative kneaded material 1 to the comparative kneaded material 3 produced in the first comparative example to the third comparative example and the comparative kneaded material 6 being the material. Specifically, the Charpy measurement of the comparative kneaded material 1 was 18.49 kj/m² while Charpy measurements of the kneaded material 1 to the kneaded material 4 produced in the first example to the fourth example were all larger than 18.5 kj/m² exceeding the Charpy measurement of the comparative kneaded material 1. As for the comparative kneaded material 4 and the comparative kneaded material 5, the raw material abruptly rose in temperature and were thermally degraded in the kneading process compared to the first example to the fourth example. Thus, Charpy impact strength thereof was unmeasurable.

As illustrated above, we confirmed that the kneaded material 1 to the kneaded material 4 produced in the first example to the fourth example have a higher mechanical property than the comparative kneaded material 1 to the comparative kneaded material 5 produced in the first comparative example to the fifth comparative example and the comparative kneaded material 6 being the material.

The PP dispersity in the kneaded material 1 produced in the first example was 61.0% as described above (see FIG. 12). As illustrated in FIG. 12, it was confirmed that the kneaded material 1 produced in the first example contains a polypropylene-based resin composition, and had an interconnection structure including a first phase made of PP (black parts in FIG. 12) and a second phase containing EPDM (white and gray parts in FIG. 12). The first and second phases were mutually connected. As illustrated in FIG. 12, a sea-island structure of the first phase and the second phase was not found in the kneaded material 1 produced in the first example.

Meanwhile, the PP dispersity in the comparative kneaded material 6 being the material was calculated by the same method as in the kneaded material. FIG. 13 depicts an image of the material. As a result, the PP dispersity in the material was 20.5%. As illustrated in FIG. 13, we found that the material has a sea-island structure of the second phase containing EPDM (white and gray parts in FIG. 13) being a sea phase and the first phase made of polypropylene (black part in FIG. 13) being an island phase. The interconnection structure of the first phase and the second phase was not found.

Thus, the improved PP dispersity and the interconnection structure of the kneaded material 1 produced in the first example were confirmed. Regarding the PP dispersity, while the PP dispersity in the material was 20.5%, the PP dispersity in the kneaded material 1 produced in the first example was 21% or greater exceeding the PP dispersity in the material.

According to our method of kneading, for example, a material containing two kinds of immiscible resins is kneaded with a conventional twin-screw extruder. That is, such a method of kneading can also be referred to as a re-kneading method of a resin composition in a virgin pellet available in the market for the purpose of improving physical property.

A resin composition in a virgin pellet, when kneaded again with a conventional twin-screw kneader, are generally degraded thermally so that the kneaded material is likely to deteriorate in physical property as compared with the virgin pellet. However, injection molded articles of the kneaded materials of the first example to the fourth example produced by rekneading the virgin pellet by our kneading method exhibit improved physical property as compared with an injection molded article of the virgin pellet of the material.

Thereby, re-kneading the virgin pellet by our kneading method can be regarded as upgraded kneading. The pellet produced by upgraded kneading and exhibiting an improved physical property than the virgin pellet can be regarded as an upgraded pellet.

Moreover, upgraded kneading by our kneading method is also applicable to plastic recycling for pulverizing and melting collected resin compositions to produce a recycled raw material such as a recycled pellet, for example. It can be easily understood that a recycled pellet, produced by upgraded kneading of a pulverized material by our kneading method, is an upgraded recycled pellet with improved physical property than a pulverized material.

While certain examples have been described, these examples have been presented by way of example only, and are not intended to limit the scope of this disclosure. Indeed, the novel examples described herein may be in a variety of other forms. Furthermore, various omissions, substitutions and changes in the form of the examples described herein may be made without departing from the spirit of the appended claims. The claims and their equivalents are intended to cover such forms or modifications as would fall within the scope and spirit of the disclosure.

1-8. (canceled)

9. A method of kneading and conveying a raw material and continuously discharging a kneaded material with a screw of an extruder, the screw comprising:
a screw body that rotates about a linear axis in a conveying direction of the raw material;
a conveyer that extends in an axial direction of the screw body and conveys, along with rotation of the screw body, the raw material along an outer circumference of the screw body in the axial direction;
a barrier provided in the screw body at a position adjacent to the conveyer, and restricts conveyance of the raw material in the axial direction; and
a passage that extends across the barrier inside the screw body, and connects an inlet and an outlet that are open to the outer circumference of the screw body, the method comprising:
conveying the raw material along a conveyance path; and
circulating the raw material in the passage, including:
increasing the raw material in pressure by restricting the conveyer from conveying the raw material by the barrier,
causing the raw material with an increased pressure to flow into the passage from the inlet located at the conveyer,
circulating the raw material having flowed into the passage to the outlet in the same direction as the conveying direction of the conveyer, and
causing the raw material having circulated in the passage to flow out from the outlet to the outer circumference of the screw body, wherein
the raw material includes a polypropylene-based resin composition containing polypropylene and olefin rubber.

10. The method according to claim 9, wherein
the conveyer includes a plurality of conveyers,
the conveyers and the barriers are alternately juxtaposed in the axial direction of the screw body, and
the conveying the raw material along the conveyance path and the circulating the raw material in the passage are repeated multiple times until the kneaded material of the raw material is discharged.

11. The method according to claim 9, wherein circumferential velocity of the screw is 0.5 m/s or more and 3.0 m/s or less.

12. The method according to claim 9, wherein an inner diameter of the passage is 1 mm or more and 8 mm or less.

13. The method according to claim 9, wherein the polypropylene-based resin composition includes a thermoplastic resin containing polypropylene of 25 mass % or more and 90 mass % or less, olefin rubber of 0.1 mass % or more and 40 mass % or less, and talc of 5 mass % or more and 55 mass % or less.

14. A kneaded material containing a polypropylene-based resin composition, wherein a dispersion of polypropylene in the kneaded material is equal to or larger than 21%.

15. A kneaded material containing a polypropylene-based resin composition, wherein the kneaded material has Charpy impact strength of 18.5 kj/m² or more.

16. A kneaded material containing a polypropylene-based resin composition, wherein the kneaded material has an interconnection structure including a first phase and a second phase coupled to each other, the first phase made of polypropylene, the second phase containing olefin rubber.
